(19) United States
(12) Patent Application Publication
(10) Pub. No.: US 2020/0375377 A1
(43) Pub. Date: Dec. 3, 2020

(54) FLORAL DESIGN MECHANIC HAVING AN INTEGRATED RESERVOIR

(71) Applicant: Syndicate Sales, Inc., Kokomo, IN (US)

(72) Inventor: Trent A. Harshman, Galveston, IN (US)

(73) Assignee: Syndicate Sales, Inc., Kokomo, IN (US)

(21) Appl. No.: 16/995,930

(22) Filed: Aug. 18, 2020

Related U.S. Application Data
(63) Continuation-in-part of application No. 16/150,723, filed on Oct. 3, 2018.

(51) Int. Cl. A47G 7/08; A47G 7/04; A01G 9/02

(52) U.S. Cl. CPC A47G 7/08; A01G 9/02; A47G 7/044

(57) ABSTRACT

A floral design mechanic includes a top shell that includes top supports and top openings defined between the top supports and a middle member including middle supports and middle openings defined between the middle supports is attached to the top shell. Both are attached to a reservoir. A plant or a portion of a plant is held in place by the floral design mechanic by inserting the stem of the plant through a top opening and a middle opening and then down into the reservoir so that the stem is supported by a top support and a middle support as well as potentially a sidewall of the reservoir. The reservoir may be filled with a liquid, such as water, to extend the life of the flowers contained in the arrangement. The floral design mechanic may be used in a free-standing configuration or the floral design mechanic may be readily secured, via known temporary or permanent methods, to another display or structure for elevated designs using the purposely located eyelets and/or openings thereon.

### CROSS REFERENCE TO RELATED APPLICATIONS

The present application is a continuation in part of U.S. patent application Ser. No. 16/150,723 filed Oct. 3, 2018, the contents of which are hereby incorporated by reference.

### BACKGROUND

The present invention pertains generally to the field of floral arrangements and specifically to floral design mechanics for creating and securing a floral arrangement, such as a bouquet, centerpiece, basket or the like. A wide range of products are used to create floral arrangements and to hold a floral arrangement in a desired shape or position. As an example, floral foam is a commonly used product that comprises a shaped foam that receives the end of a stem of a flower used in the floral arrangement. The stem of the flower is forced into the foam so that the foam supports the flower at a particular position. However, with floral foam, the flower is only supported at one location making it easy for the flower to be knocked out of position while moving the arrangement. Additionally, since only the end of the flower is supported, it is difficult to keep flowers at an extremely angled position within the bouquet or arrangement. Alternative methods include the use of chicken wire or flower frogs to support floral arrangements. More recent improvements involve the use of a purpose made and reusable floral design mechanic. Such mechanics often include a top shell that includes top supports and top openings defined between the top supports. A bottom shell including bottom supports and bottom openings defined between the bottom supports is attached to the top shell. A plant or a portion of a plant is held in place by the floral design mechanic by inserting the stem of the plant through a top opening and a bottom opening so that the stem is supported by a top support and a bottom support. The floral design mechanic is used without a container or may be placed at least partially within a vase.

In one form, the floral design mechanic also includes a flat bottom to enable it to sit on its own in a free-standing configuration upon a support surface when desired. In addition, the floral design mechanic may be readily secured, via known temporary or permanent methods, to another display or structure for elevated designs using the purposely located eyelets and/or openings thereon.

All of the above solutions serve the desired purpose, however, none provide the ability to easily provide a reservoir of water or other selected liquid in order to extend the life of the flowers. Thus, there is a need for improvement in this field.

### SUMMARY

Certain embodiments include a floral design mechanic for arranging and securing a bouquet or arrangement of flowers or other decorative plants which includes an integrated reservoir for water. In one form, a floral design mechanic includes a top shell having a top outer edge. The top shell includes top supports and top openings defined between the top supports. The floral design mechanic also includes a reservoir having a reservoir outer edge. The reservoir includes an interior cavity for retaining water therein and is attachable to the top shell. Another interior cavity is defined between the top shell and the reservoir outer edge when the top shell is attached to the reservoir.

The floral design mechanic is configured to secure a plant or a portion of the plant by accepting a stem that extends through one of the top openings and into the reservoir. The top supports surrounding the top opening and the interior walls or surface of the reservoir keep the plant constrained to a general location and placement within the floral arrangement.

In some embodiments, the floral design mechanic includes at least one connection prong positioned on either the top outer edge or said reservoir outer edge. The connection prong corresponds to a prong reception member positioned on either the top outer edge or the reservoir outer edge, opposite of the connection prong. The connection prong couples to the prong reception member to attach the top shell to the reservoir.

In some instances, a floral design mechanic may have one of a number of different shapes, so as to be configured for and/or used with a vase, as a hanging arrangement or the like. The vase may have a base and a top rim with an inner surface. A body defining a hollow interior extends between the base and the top rim. The floral design mechanic is supported by the inner surface of the vase. A stem of a plant is inserted through a top opening through the hollow interior and subsequently into the reservoir. In certain embodiments, the floral design mechanic is positioned on the vase so that at least a portion of the floral design mechanic extends above the top rim of the vase.

In another form, a floral design mechanic includes a top shell having a top outer edge, a middle layer having middle supports forming middle openings and a reservoir having a reservoir outer edge. The reservoir includes an interior cavity for retaining water therein and is attachable to both the middle layer and the top shell.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a top perspective view of one embodiment of a floral design mechanic according to the present invention, showing its two main parts separately.

FIG. 2 is a front perspective view of the reservoir, absent the top shell, of the floral design mechanic of FIG. 1.

FIG. 3 is a rear perspective view of the reservoir, absent the top shell, of the floral design mechanic of FIG. 1.

FIG. 4 is a side view of the reservoir, absent the top shell, of the floral design mechanic of FIG. 1.

FIG. 5. is a top perspective view of the floral design mechanic of FIG. 1, showing its two main parts assembled.

FIG. 6. is a front view of a simple wedding arch having two of the floral design mechanics of FIG. 1 mounted thereto.

FIG. 7. is a top perspective view of a middle member according to one embodiment of the present invention.

FIG. 8. is a top perspective view of the floral design mechanic of FIG. 1, showing its two main parts assembled in conjunction with a middle member.

FIG. 9. is a detailed view showing the securement means for attaching the middle member to the top shell of the floral design mechanic of FIG. 1.

FIG. 10. is a detailed view showing an alternate version of the securement means for attaching the middle member to the top shell of the floral design mechanic of FIG. 1.

FIG. 11 is a top perspective view of a sloped reservoir, absent a top shell, of an alternate embodiment of floral design mechanic according to the present invention.

FIG. 12 is a perspective view of the sloped reservoir of FIG. 11, combined with the top shell shown in FIG. 1 and the middle member shown in FIG. 9.

FIG. 13 is a top perspective view of a round and sloped reservoir, absent a top shell, of an alternate embodiment of floral design mechanic according to the present invention.

FIG. 14 is a side plan view of the round and sloped reservoir of FIG. 13.

FIG. 15 is a side view of the rounded and sloped reservoir of FIG. 13, combined with a top shell and middle member.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

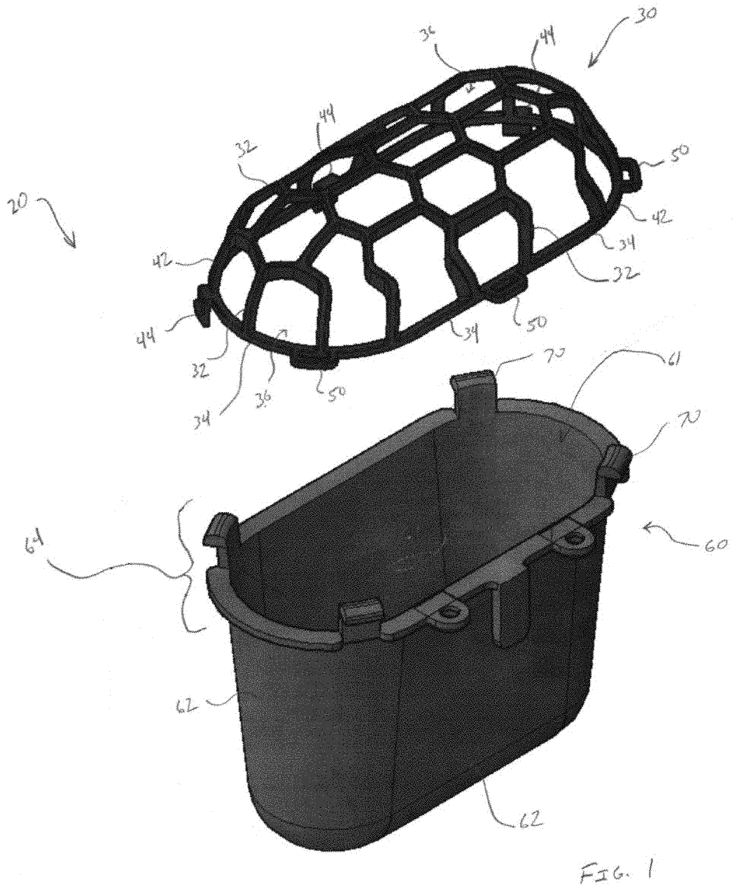

FIG. 1 illustrates a top perspective view of one embodiment of a floral design mechanic 20. Floral design mechanic 20, shown in its disassembled state, includes a top shell 30 and a reservoir 60. Top shell 30 and reservoir 60 are releasably attached to each other, allowing floral design mechanic 20 to be split into two separate pieces. As shown in this form, top shell 30 of floral design mechanic 20 has an oblong, pill-like shape, such as for creating horizontal bouquets and the reservoir follows this oblong rounded profile. Other shapes are contemplated, including (but not limited to) obround, circular, square and the like.

Top shell 30 includes a series of top supports 32 that collectively form a frame with a lattice-type arrangement. Top openings 36 are voids defined through top shell 30 between the series of top supports 32. In the embodiment shown, top openings 36 come in a variety of shapes. Some of top openings 36 are quadrilateral, pentagonal, or hexagonal. In other embodiments, different shapes and/or sizes for top openings 36 may be used or top shell 30 may include top openings 36 that are all the same shape.

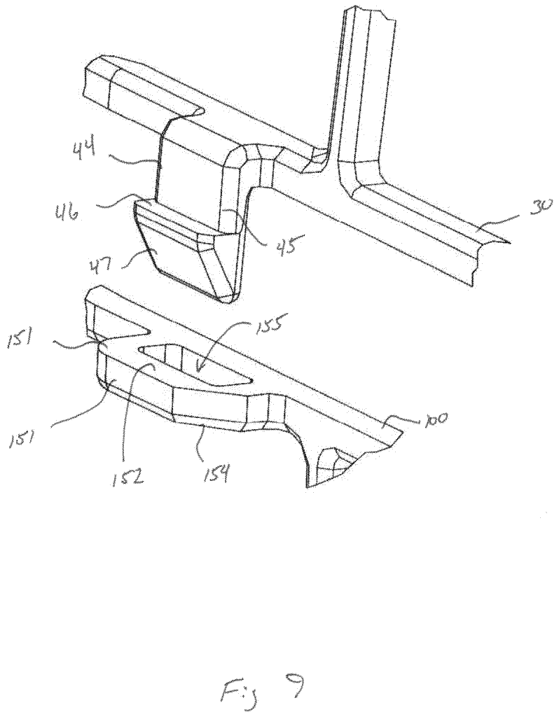

Top shell 30 includes a top outer edge 42 which is defined by perimeter supports 34. Top connection prongs 44 and top prong reception members 50 are spaced around top outer edge 42. In the embodiment shown, one half of the top outer edge 42 of top shell 30 includes top connection prongs 44 and the other half of outer edge 42 of top shell 30 includes top prong reception members 50. These components enable the securement to another part, such as the middle member of FIG. 9, but may alternatively be used to attach to the reservoir. In other embodiments, the arrangement of top connection prongs 44 and top prong reception members 50 may be modified. As an example, top connection prongs 44 and top prong reception members 50 may alternate around outer edge 42. In other instances, outer edge 42 may include only top connection prongs 44 or may include only top prong reception members 50. In alternate embodiments, other connection types may be utilized, such as snap-fit, clips or other known alternatives.

Reservoir 60 is sized so as to mate with top shell 30. Reservoir 60 provides an interior cavity 61 which is suitable for containing a volume of water or other desirable liquid for extending the life of a flower or floral arrangement mounted to floral design mechanic 20. Reservoir 60 includes a sidewall 66, a top portion 68 and a number of reservoir connection prongs 70 spaced around reservoir outer edge 64. In the embodiment shown, reservoir outer edge 64 includes four reservoir connection prongs 70 spaced at the relative corners of reservoir 60 for selectively securing the top shell 30 to the reservoir 60. To do so, these reservoir connection prongs attach to the perimeter supports 34 of top shell 30, which could be configured or otherwise contoured at the appropriate position to accommodate reservoir connection prongs 70. In other embodiments, the arrangement of reservoir connection prongs 70 may be modified, but should not overlap or conflict with top connection prongs 44. In other instances, reservoir outer edge 64 may include reservoir connection prongs 70 or also reservoir prong reception members (not shown), which may be capable of receiving top connection prongs 44. In alternate embodiments, other connection types may be utilized, such as snap-fit, clips or other known alternatives.

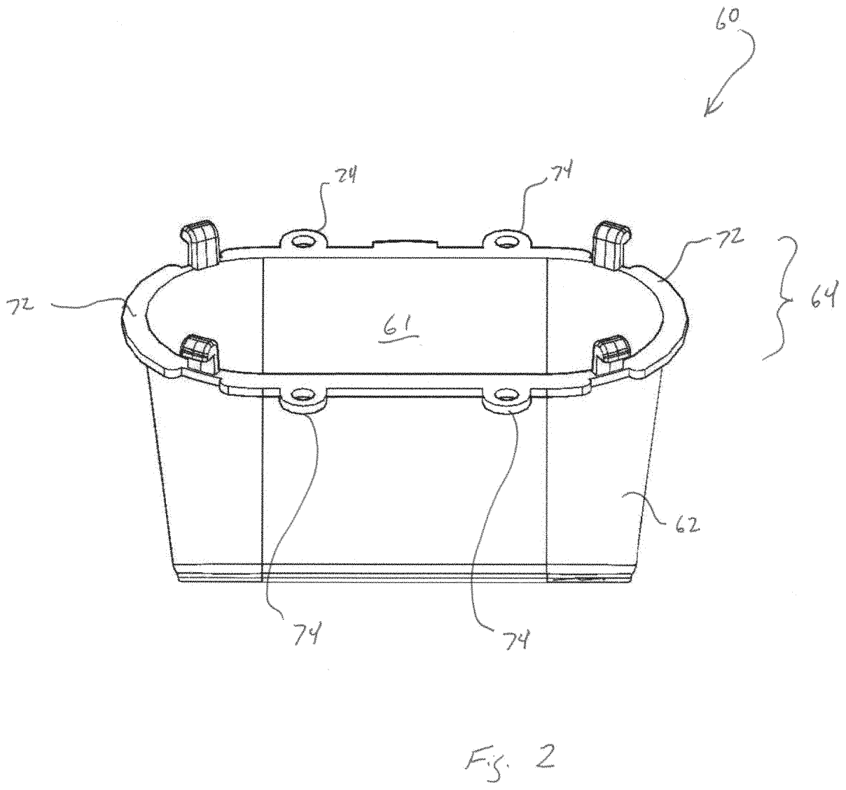

Turning to FIG. 2, with continued reference to FIG. 1, a front perspective view of reservoir 60, absent top shell 30, according to one embodiment of a floral design mechanic 20 is shown. Included on top portion 64 of reservoir 60 are reservoir outer edge 72, eyelets 74 and attachment clip 76. Also present is a lip 78 which is formed by the intersection of the sidewall 62 and reservoir outer edge 72. Eyelets 74 provide a point of attachment so that the floral design mechanic 20 may be secured to or hung from another structure, such as a trellis, arbor, archway, pew, or other structure upon which floral decoration is desired. In the illustrated form, two eyelets 74 are provided along one side of reservoir outer edge 72 of reservoir 60. It shall be appreciated that more or fewer eyelets 74 may be provided, and that their locations may vary, depending upon the intended use.

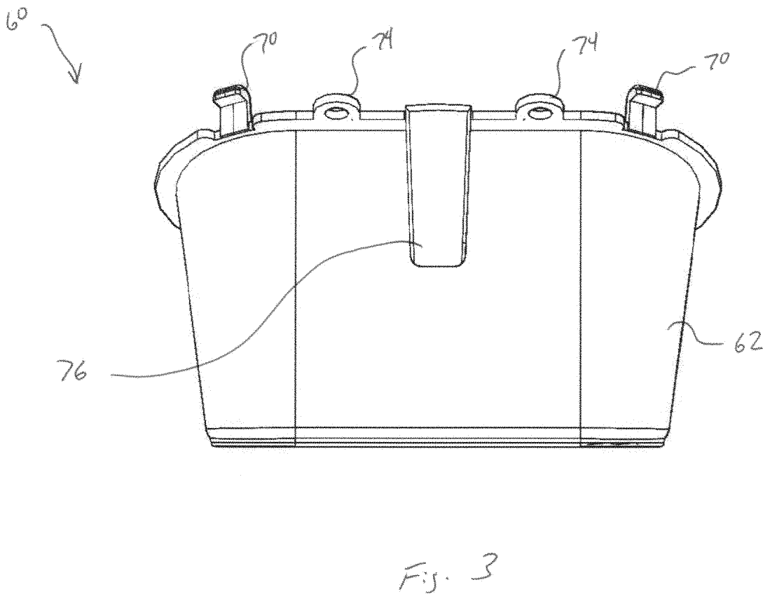

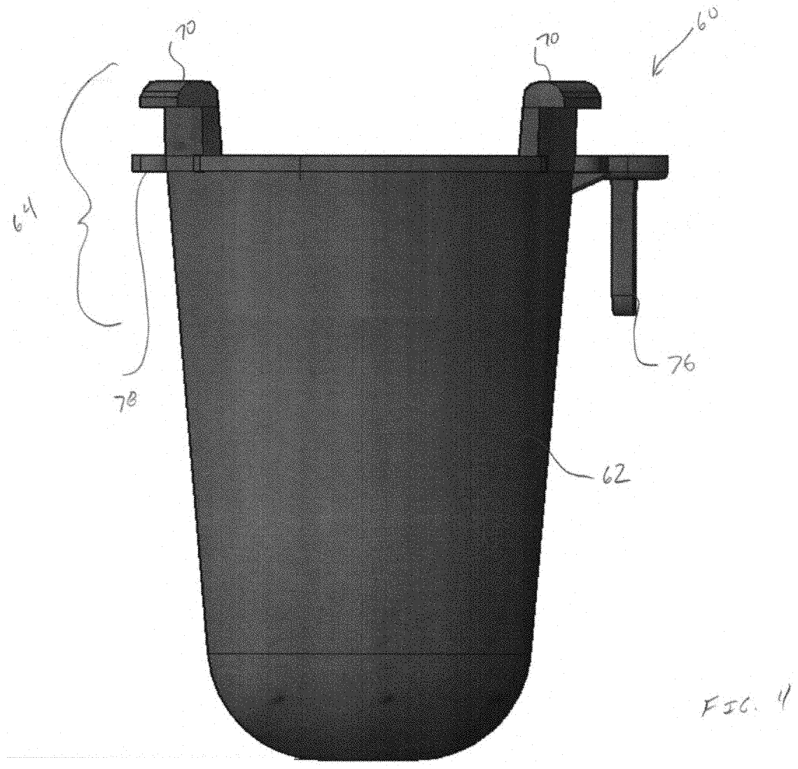

Turning to FIGS. 3 and 4, with continued reference to FIGS. 1-2, a rear perspective view and a side perspective view of reservoir 60, absent top shell 30, according to one embodiment of a floral design mechanic 20 are shown. Provided on reservoir outer edge 72 is an attachment clip 76 which extends vertically down from reservoir outer edge 72 some distance apart from sidewall 62. As such, attachment clip 76 may be used to clip or otherwise hang floral design mechanic 20 from a string, rope, ribbon, zip tie or other suitable mounting surface. Alternatively or additionally, a string, zip tie, rope, ribbon or other similar material may be tightly secured under lip 76 in order to secure floral design mechanic 20 in the desired position and orientation.

In an alternate form, reservoir 60 may include reservoir connection prongs 70 and bottom prong reception members (not shown) spaced around bottom outer edge 72 to correspond with top prong reception members 50 of top shell 30. In other embodiments, where the arrangement of top connection prongs 44 and top prong reception members 50 on top shell 30 is modified, the arrangement of bottom connection prongs and bottom prong reception members would also modified.

It shall be appreciated that the reservoir 60 shown in FIGS. 1-4 may have either of the forms shown, one of which includes a squared bottom shape so as promote maximum contact with a surface upon which it may rest and the other provides a more rounded shape, which promotes a softer appearance and less harsh profile for use when the mechanic may be hung as opposed to support from the bottom. It shall be appreciated that the two designs may be substituted for one of another herein, without departing from the description of the related features of the invention.

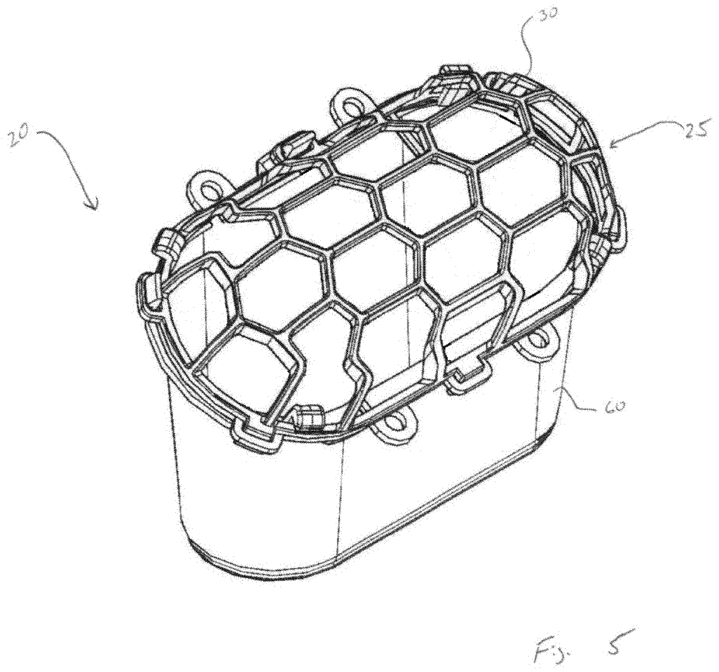

Shown in FIG. 5 is a perspective view of an assembled floral design mechanic 20 according to one embodiment of the present invention. Floral design mechanic 20 provides a lightweight, easy to handle structure for a floral arrangement or bouquet of flowers (not shown) that keeps the arrangement intact during construction. The upper interior cavity 25 of floral design mechanic 20, formed between the top of reservoir 60 and the inner portion of top shell 30, remains empty, without the addition of floral foam or any other material which supports the stems of the flowers used in the bouquet. The floral design mechanic allows a florist or designer to insert flower stems at all angles and keep them in a horizontal fan-shaped or asymmetrical array without the flowers popping to a vertical position when the stem handle is tied.

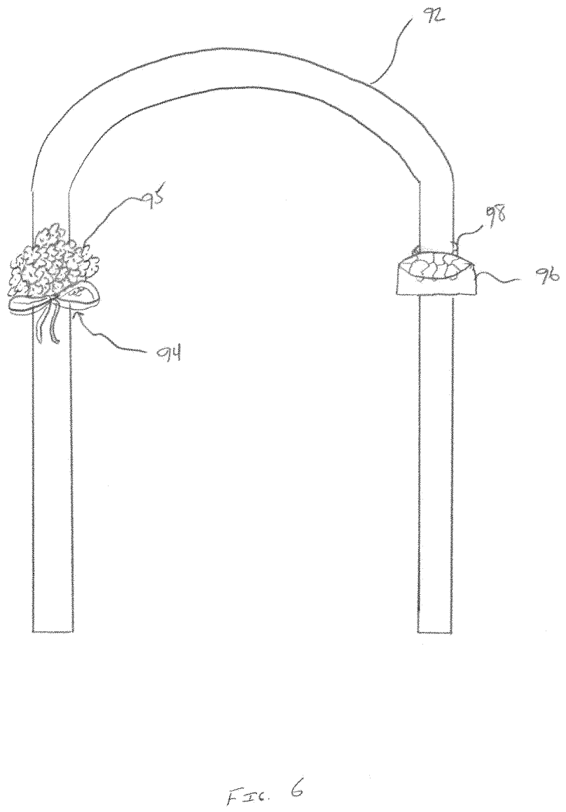

As shown in FIG. 6, a simple wedding arch 92 is provided. The wedding arch 92 may be decorated using one or more floral design mechanics 20, such as floral design mechanic 94 and 96, which are shown in FIG. 6. Here, the floral design mechanic 92 is hidden from view by the flowers mounted therein which create the floral arrangement 95 which adorns the left side of the arch 92. The floral design mechanic 96 is similarly mounted to the right hand side of the arch 92, but is shown without a floral arrangement therein to provide clarity. In this form, the floral design mechanic 96 is attached to the arch 92 using a zip-tie 98 or the like which feeds through the eyelets 74 of the reservoir 60 and secures it to the arch 92. While not shown, it shall be appreciated that floral design mechanic 94 may be similarly mounted. Alternative methods of mounting include the use of a nail, rope or string, or the like and may make use of the eyelets 74, attachment clip 76 or any other structural component of the floral design mechanic 20.

In one method of use, the structure of the bouquet 95 is maintained by securing the stems of flowers to the supports 32 of top shell 30. The stems may be secured to supports 32 by wire or by any other suitable attachment mechanism. The open ended design allows stems to extend through the top shell 30 and into the reservoir 60 of floral design mechanic 20. Moreover, the inner sidewall or base of the reservoir 60 may provide further support to the flowers 90 so that one stem can be supported at two points. This assists to secure the flower in the desired position in the bouquet while also allowing for built-out, cascading bouquets. If further securement points are desired, that can also be accommodated as described later herein.

By securing stems of flowers in the bouquet at supports 32 of top shell 30 of floral design mechanic 20, the stems of each of the flowers are separated so that each bloom in the bouquet can be seen. This reduces the number of flowers and stems needed to fill the bouquet.

As the arrangement is created, the user may set down the floral design mechanic 20 to take a break, while the flowers attached to floral design mechanic 20 remain in the position at which they were arranged. In other instances, the user may place the floral design mechanic 20 on a vase to support floral design mechanic 20 while the bouquet is designed rather than having to hold floral design mechanic 20 during design and arrangement.

Once the bouquet is completed, floral design mechanic 20 is easily hidden. As an example, in some embodiments, floral design mechanic 20 is hidden by a collar of green leaves. Other embodiments may use other suitable materials or techniques to hide floral design mechanic 20; however, in some instances, floral design mechanic 20 may not be hidden, but instead remains visible. Floral design mechanic 20 and the stems of the flowers used in the bouquet can also be easily placed into water to prolong the life of the flowers and the bouquet.

In some embodiments, a bouquet or arrangement designer may use wired stems for the flowers in the bouquet or arrangement. The wired stems may be twisted into the interior of floral design mechanic 20 to provide additional support. In some embodiments, a designer may include succulents or pods on the frame, either with stemmed flowers or for a bouquet that only includes succulents and/or pods.

The presence of water, or some other liquid selected by the florist or designer and being placed within the reservoir 60 provides nutrients and moisture to the flowers in the bouquet or arrangement, thereby prolonger their beauty and life significantly.

The separable top shell 30 and reservoir 60 allows floral design mechanic 20 to be reduced in size for storage. Top shell 30 is removed from reservoir 60 and shell 30 can be nested within the interior 62 of reservoir 60 to minimize storage space needed for floral design mechanic 20. Also, the parts are interchangeable and reusable, as they may be formed from a durable material such as plastic or the like.

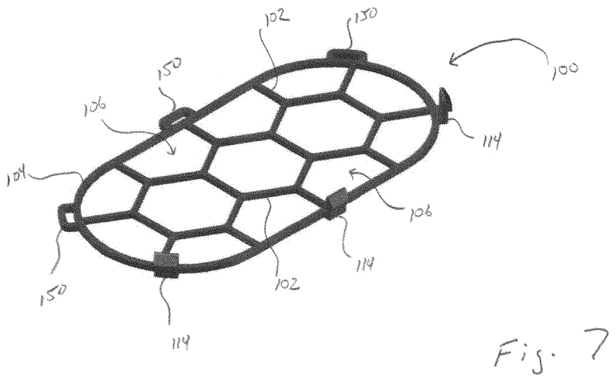

Shown in FIG. 7 is an optional middle member 100 which includes a series of middle supports 102 that collectively form a frame with a lattice-type arrangement. In the illustrated embodiment, middle member 100 is flat, but may take on a more arcuate or three-dimensional shape as desired. Much like top shell 30, middle member includes middle openings 106 which are voids defined through middle member 100 between the series of middle supports 102. In the embodiment shown, middle openings 106 come in a variety of shapes. Some of middle openings 106 are quadrilateral, pentagonal, or hexagonal. In other embodiments, different shapes and/or sizes for middle openings 106 may be used or middle member 100 may include middle openings 106 that are all the same shape.

Middle member 100 includes middle outer edge 104 which is defined by middle supports 102. Middle connection prongs 114 and top prong reception members 150 are spaced around middle outer edge 104. In the embodiment shown, one half of the middle outer edge 102 of middle member 10 includes middle connection prongs 114 and the other half of middle outer edge 104 of middle member 100 includes middle prong reception members 150. In other embodiments, the arrangement of middle connection prongs 114 and middle prong reception members 150 may be modified as is described above with respect to top shell 30, including the alternative use of snap-fit, clips or other known alternatives.

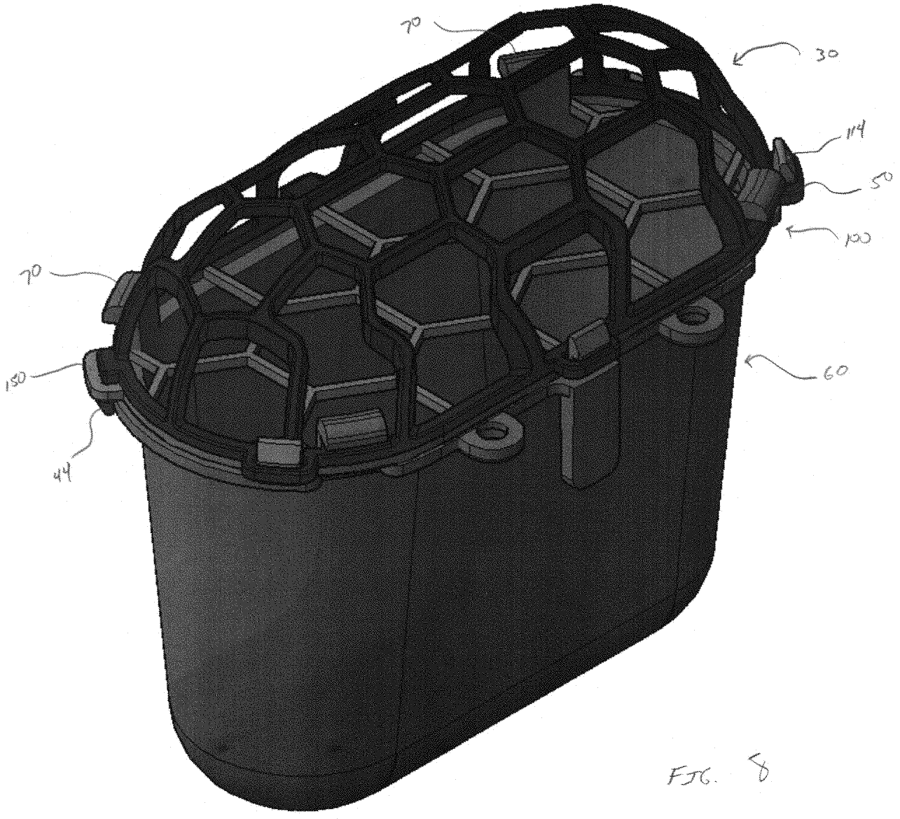

As shown in FIG. 8, top shell 30 and middle member 100 in the illustrated embodiment are connected by interlocking top connection prongs 44 with corresponding middle prong reception members 150 and interlocking middle connection prongs 114 with corresponding top prong reception members 50. Reservoir 60 may separately connect to either middle member 100 or top shell 30 at other locations along middle outer edge 102 or top outer edge 42 or middle outer edge 104, such as by using reservoir connection prongs 70. In another form, middle member 100 may only include recesses along its middle outer edge 104 through which the connections between top shell 30 and reservoir 60 pass, thereby securing middle member in place. Any number of connection options may be provided.

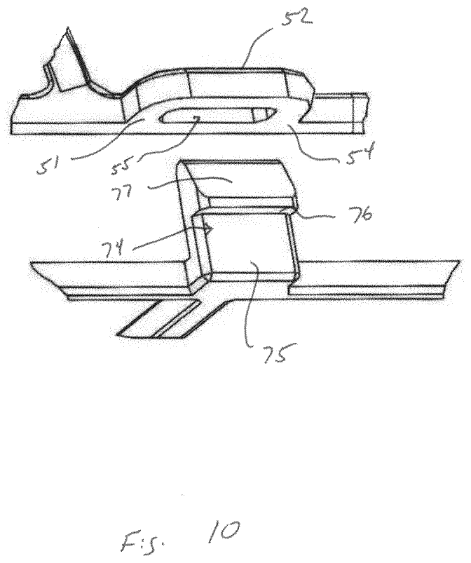

Turing to the details of the connection and attachment means, as shown in FIGS. 9 and 10, top connection prong 44 includes a body 45. An extension 46 projects from body 45 and a tapered surface 47 is provided between extension 46 and an end surface 48 of connection prong 44. Middle prong reception member 150 includes a projection 151 that extends from outer edge 104 of middle member 100. Projection 81 includes a top surface 82 and a bottom surface 84. A prong opening 85 is defined through projection 81 and extends completely through top surface 82 and bottom surface 84.

Connection prongs 44 and 114 connect to prong reception members 50 and 150 using a snap fit mechanism. To interlock top connection prong 44 with middle prong reception member 150, end surface 48 of connection prong 44 is inserted into prong opening 155. Connection prong 44 is advanced so that tapered surface 47 extends through prong opening 155 until extension 46 clears bottom surface 154 of projection 151. Once extension 46 clears bottom surface 1544, connection prong 44 flexes outward so that extension 46 contacts bottom surface 154 when top shell 30 is pulled away from middle member 100. This connects top shell 30 and middle member 1000 and assists to prevent accidental separation of the two. The interaction between middle connection prong 114 and top prong reception member 50 is symmetrical to the interaction between top connection prong 44 and middle prong reception member 150, as should be appreciated by one of skill in the art. The interface between reservoir connection prongs 70 of reservoir 60 and perimeter supports 34 of top shell 30 may also work in a similar manner.

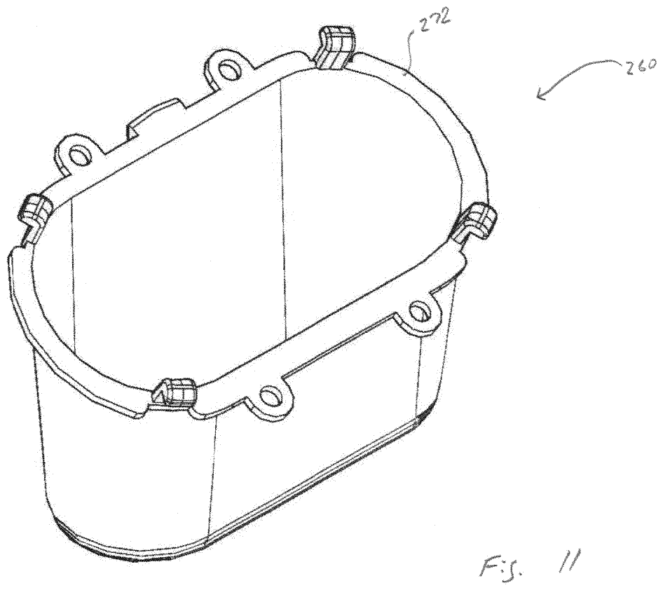

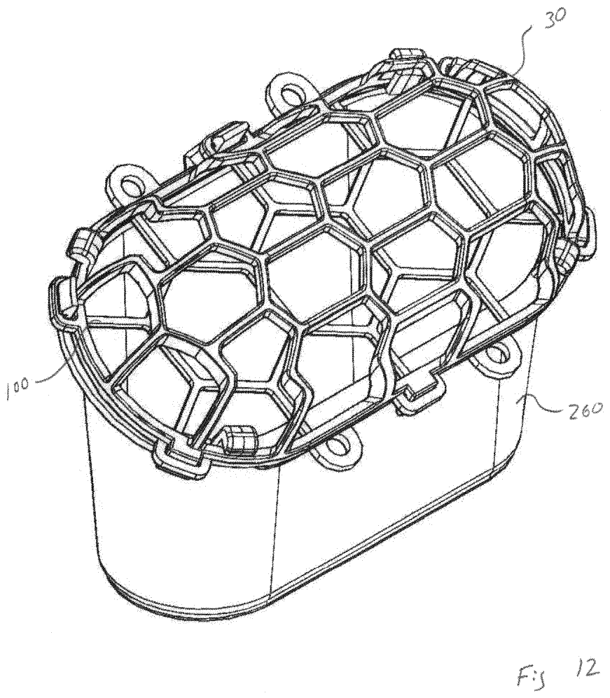

Turning to FIG. 11, an alternate embodiment of the reservoir of FIG. 1 is shown as reservoir 260. Reservoir 260 includes a sloped reservoir outer edge 272 thereby promoting a forward facing arrangement. This type of floral arrangement is prevalent when hanging from an arbor or arch, against a wall, from the end of a church pew, or the like. Otherwise, the components of reservoir 260 are similar to those of reservoir 60 of FIG. 1-6. Shown in FIG. 12 is a perspective view of an assembled floral design mechanic utilizing the reservoir 260 along with top shell 30 and middle member 100.

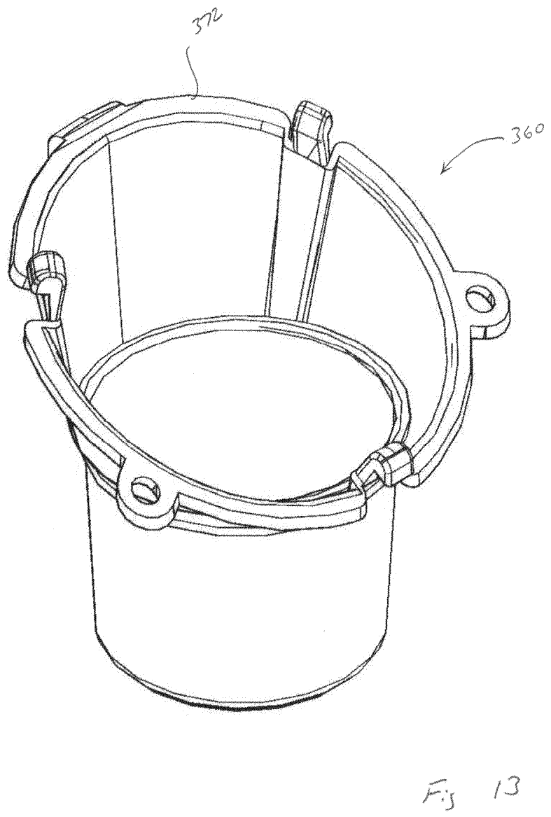

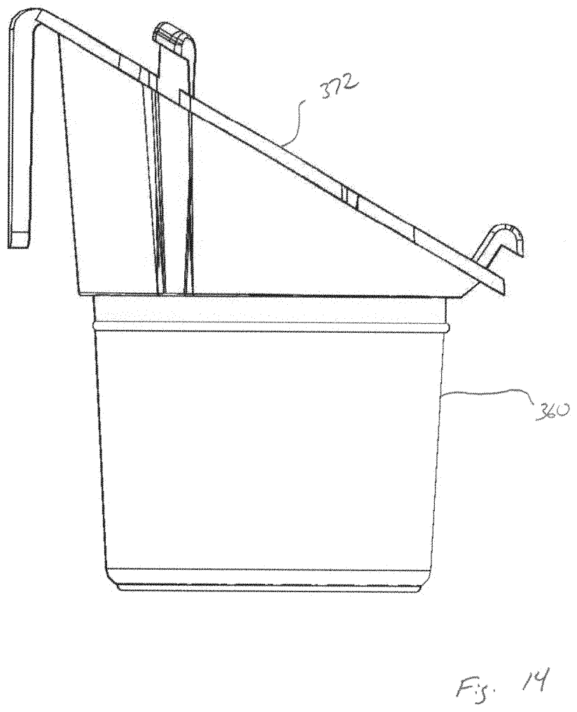

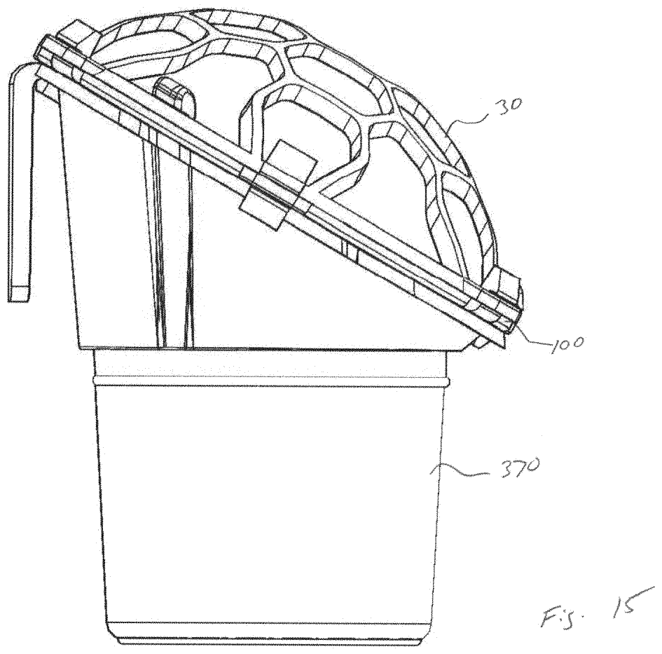

Shown in FIGS. 13-14 is yet another alternate embodiment of the reservoir of FIG. 1. Reservoir 360 includes a circular shaped reservoir having a sloped reservoir outer edge 372 thereby promoting a forward facing arrangement. Moreover, the circular shape provides from a narrower arrangement or alternatively enables the reservoir 360 to be placed into a vase. Otherwise, the components of reservoir 360 are similar to those of reservoir 60 of FIG. 1-6. Shown in FIG. 15 is a perspective view of an assembled floral design mechanic utilizing the reservoir 360 along with a circular top shell and circle middle member. In a further form, one or more of the reservoirs described herein could include one or more spikes extending vertically downward from the bottom of the reservoir to enable to floral design mechanic and the resulting floral arrangement to be mounted in place in the ground or elsewhere.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A floral design mechanic having an integrated reservoir comprising:
a top shell including a plurality of top openings defined between top supports, wherein said top shell includes a top outer edge;
a reservoir having a first interior cavity suitable for storing liquid and a reservoir outer edge formed on a top portion of the reservoir; wherein said reservoir is attachable to said top shell;
at least one connection means for selectively securing the top shell to the reservoir, the at least one connection means located on either said top outer edge or said reservoir outer edge;
at least one attachment means for connecting to the connection means, wherein the attachment means is positioned opposite of the at least one connection means and on either said top outer edge or said bottom outer edge, and
wherein said connection means and said attachment means collectively secure said top shell to said reservoir, forming an second interior cavity defined between said top shell and the top of said reservoir.

2. The floral design mechanic of claim 1, wherein the plane defined by the reservoir outer edge is parallel to the plane defined by the bottom of the reservoir.

3. The floral design mechanic of claim 1, wherein the plane defined by the reservoir outer edge is offset by at least 10 degrees from the plane defined by the bottom of the reservoir.

4. The floral design mechanic of claim 3, wherein the plane defined by the reservoir outer edge is offset by at least 30 degrees from the plane defined by the bottom of the reservoir.

5. The floral design mechanic of claim 3, wherein the plane defined by the reservoir outer edge is offset by between 20 and 50 degrees from the plane defined by the bottom of the reservoir.

6. The floral design mechanic of claim 1, wherein the floral design mechanic is configured to secure a plant or a portion of the plant by accepting a stem that extends through one of said top openings and into the first interior cavity of the reservoir.

7. The floral design mechanic of claim 1, further comprising:
a middle member, having a plurality of middle openings defined between middle supports, wherein said middle member includes a middle outer edge;
at least one securement means on the middle outer edge for securing the middle member to either the top shell or the reservoir and in a position between the top member and the reservoir.

8. The floral design mechanic of claim 7, wherein the floral design mechanic is configured to secure a plant or a portion of the plant by accepting a stem that extends through each of one of said top openings and one of said middle openings and into the first interior cavity of the reservoir.

9. The floral design mechanic of claim 1, wherein the top outer edge or the reservoir outer edge includes a plurality of hanging means to enable to floral design mechanic to be secured to another structure.

10. The floral design mechanic of claim 1, wherein the top outer edge or the reservoir outer edge includes a plurality of eyelets enabling the floral design mechanic to be secured to another structure.

11. The floral design mechanic of claim 1, wherein the reservoir outer edge has a first outer dimension and a body of the reservoir has a second outer dimension, and the first outer dimension is greater than the second outer dimension.

12. The floral design mechanic of claim 1, wherein the reservoir includes a lip at the top portion bounded by the reservoir outer edge.

13. The floral design mechanic of claim 12, wherein reservoir has a sidewall and the lip protrudes outward from the sidewall by at least 0.125 inches.

14. The floral design mechanic of claim 1, wherein the reservoir outer edge is circular in shape.

15. The floral design mechanic of claim 14, wherein the reservoir has a cylindrical shape.

16. The floral design mechanic of claim 14, wherein the reservoir has a tapered cylindrical shape with the largest diameter located in the top portion.

17. The floral design mechanic of claim 1, wherein the reservoir outer edge has an obround shape.

18. The floral design mechanic of claim 1, wherein the reservoir has a clip integrally formed therein for mounting the floral design mechanic to a structure.

19. The floral design mechanic of claim 1, wherein the reservoir has a base connected to the sidewall at the end opposite of the reservoir outer edge and a spike extending vertically downward from said base.

20. A floral design mechanic having an integrated reservoir comprising:
a plastic top shell including a plurality of top openings defined between top supports, wherein said top shell includes a top outer edge;
a plastic reservoir having a first interior cavity suitable for storing liquid and a reservoir outer edge formed on a top portion of the reservoir; wherein said reservoir is attachable to said top shell;
at least one connection prong positioned on either said top outer edge or said reservoir outer edge; and
at least one prong reception member positioned on either said top outer edge or said reservoir outer edge, opposite said connection prong;
wherein said connection prong couples to said prong reception member to attach said top shell to said reservoir.

21. The floral design mechanic of claim 19,
wherein said connection prong includes a body and an extension extending from said body;
wherein said prong reception member includes a projection having a top surface and a bottom surface; and
wherein after said connection prong is inserted through said connection opening, said connection prong flexes so that said extension of said connection prong contacts said bottom surface of said projection of said prong reception member to prevent said connection prong from being removed from said connection opening.
